(19) United States
(12) Patent Application Publication
(10) Pub. No.: US 2024/0015432 A1
(43) Pub. Date: Jan. 11, 2024

(54) SYSTEM, METHOD AND COMPUTER PROGRAM PRODUCT FACILITATING EFFICIENCY OF A GROUP WHOSE MEMBERS ARE ON THE MOVE

(71) Applicant: ELTA SYSTEMS LTD., Ashdod (IL)

(72) Inventors: Erez SHARON, Karmei Yosef (IL); Slava KANDIBA, Ashdod (IL); Noam FRENKEL, Karmei Y osef (IL); Hen PINTO, Cesaria (IL)

(21) Appl. No.: 18/254,277

(22) PCT Filed: Nov. 1, 2021
(86) PCT No.: PCT/IL2021/051288

§ 371 Date: May 24, 2023

(30) Foreign Application Priority Data
Nov. 29, 2020 (IL) 279076
May 24, 2021 (IL) 283637

(51) Int. Cl. H04R 1/40; H04R 3/00; H04R 3/12; H04R 27/00; G01C 21/00; G01S 5/20

(52) U.S. Cl. CPC H04R 1/406; H04R 3/005; H04R 1/403; H04R 3/12; H04R 27/00; G01C 21/005; G01S 5/20; H04R 2201/401; H04R 2227/003

(57) ABSTRACT

An acoustic many-to-many localization, communication and management system serving a group whose members are moving or maneuvering, the system comprising plural portable hardware devices which may be distributed to plural group members respectively, each device including at least one array of speakers and/or at least one array of microphones, and/or at least one hardware processor, some or all typically co-located. Typically, the hardware processor in at least one device d1 from among the devices controls d1's speaker to at least once broadcast a first signal (e.g. “localization request signal”) at a time t_zero. Typically the hardware processor in device d1 at least once computes at least one of angle and distance between d2 and d1, to monitor locations of other group members who may be on the move.

### FIELD OF THIS DISCLOSURE

The present invention relates generally to devices and more particularly to portable devices.

### BACKGROUND FOR THIS DISCLOSURE

Use of PPS (pulse per second) signals for accurate time measurement is known. For example, a PPS signal may be connected to a computer e.g. PC or personal computer e.g. using a low-latency, low-jitter wire connection and a program may be allowed to synchronize to the computer, yielding a PC (say) which functions as a stratum-1 time source.

Other known methods include GPS time and NTP protocols for synchronizations.

In-prep.eu describes that “c2 is a command and control communication system used in disaster contexts. When faced with a large crisis, civil protection agencies and first response organizations depend on their mobile radios for critical communication, to collaborate and deal with the event as it unfolds. These organizations have specific protocols for a response during crises, including an IT and Communications System—known as a C2 system.” More generally, C2 refers to coordinating various groups to accomplish an objective, mission or task.

Localization systems are described in the following patent documents: U.S. Pat. No. 7,362,656 to Holm, CN1981206, WO05085897, U.S. Pat. No. 7,710,829 to Wei et al, WO17107263 and CN205384363.

Acoustic localization is known;

(https://en.wikipedia.org/wiki/3D_sound_localization describes 3D sound localization which refers to an acoustic technology that is used to locate the source of a sound in a three-dimensional space.

Threat identification using acoustic signatures is known e.g.

https://www.hsaj.org/articles/72.

Threat identification on the move is known, such as Microflown Avisa devices on UAVs.

Existing acoustic localization and positioning systems which are ultrasonic, are known and are available, for example, from hexamite.com.

An acoustic detection and localization system is described here:

http://www.conforg.fr/cfadaga2004/master_cd/cd1/articles/000658.pdf

WAZE is an example of a navigation application which uses topographic data.

Chirp signals are known and are described e.g. here: https://dspguide.com/ch11/6.htm

“Semi-supervised source localization with deep generative modeling” is described in an article by that name, dated 30 Jul. 2020, by Michael J. Bianco, Sharon Gannot, and Peter Gerstoft.

Source localization is also described in Hadrien Pujol, Eric Bavu, Alexandre Garcia, “Source localization in reverberant rooms using Deep Learning and microphone arrays”, 23rd International Congress on Acoustics (ICA 2019 Aachen), Sep 2019, Aachen, Germany.

Wikipedia (https://en.wikipedia.org/wiki/Identification_friend_or_foe) describes that “Identification, friend or foe (IFF) is a radar-based identification system [which] listens for an interrogation signal and then sends a response that identifies the broadcaster. It enables military and civilian air traffic control interrogation systems to identify aircraft, vehicles or groups as friendly and to determine their bearing and range from the interrogator.”

Wikipedia

(https://en.wikipedia.org/wiki/Automatic_dependent_surveillance_% E2%80%93_bro adcast) describes that “Automatic_dependent_surveillance—broadcast (ADS-B) is a surveillance technology in which an aircraft determines its position via satellite navigation and periodically broadcasts it, enabling it to be tracked. The information can be received by air traffic control ground stations as a replacement for secondary surveillance radar, as no interrogation signal is needed from the ground. It can also be received by other aircraft to provide situational awareness and allow self-separation. ADS—B is “automatic” in that it requires no pilot or external input. It is “dependent” in that it depends on data from the aircraft's navigation system”.

An ultrasonic speech translator and communications system is described in a Lockheed Martin patent document: https://patents.google.com/patent/U.S. Pat. No. 5,539,705A/en.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

Walkie talkies use radio waves to communicate wirelessly with one another and typically include a transmitter-receiver, antenna for sending/receiving radio waves, loudspeaker/microphone, and a button which end-users push when they seek to speak to other end-users.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a practical and/or inexpensive and/or lightweight system to improve efficiency of a group on the move, typically using very little hardware to achieve this aim.

The word “group” as used herein may for example refer to a team, each of whose members may be independently moving through a region or terrain, where the members may include humans and/or vehicles and/or robots, and/or drones. Conversely, any references herein to a “team” may optionally be replaced by more general references to a group.

Certain embodiments seek to provide a practical and/or inexpensive and/or lightweight system to improve efficiency of a group e.g. team of humans on the move, typically using very little hardware to achieve this aim.

Certain embodiments seek to provide a method for monitoring and knowing the whereabouts of team members' locations (direction and/or distance from a reference point e.g. the location of a given team member such as the team member sending the location request or query). many to many communication may be provided; and the system may rely only on acoustics without resorting to GPS and/or to RF and/or to Acoustics to count team members and/or to know team members' locations. The method and system may be used to detect phenomena such as threats or positive events relevant to the team and/or may be used as a beacon for homing and/or for marking and/or may be used to talk within the team in natural language and/or may be used to send commands to team members.

Certain embodiments seek to provide a device which facilitates communication e.g. internal team communication (e.g. team members speak between them in natural language and/or issue auto-commands to one another or to or between devices such as robots/drones etc, and/or localizes other devices e.g. devices held by other team members and/or alerts about moving events e.g. threats or positive events which a team member has detected and/or alerts that certain team members have strayed or about to stray out of a pre-defined range, and/or has homing functionality, and/or has location marking functionality, and/or can count team members e.g. perform a roll call or take attendance or count team members, e.g. as described herein. The device may have suitable signal conversion ability such that signals travelling between devices may be ultrasonic.

Problems and needs which plague a group e.g. team of humans on the move may include all or any subset of:

Knowing the location of each team member. There are few if any practical solutions for knowing the location and whereabouts of each team member at all—let alone in real time, on the move or without resort to GPS or for use outdoors.

Communicating between team members, typically including communicating natural speech and/or communicating a selected command from a library of commands or sending information like medical data. The communication e.g. command may be selected either automatically by a device, e.g. triggered by certain sensed events, or may be selected by a human e.g. via a button (e.g. emergency button) or other (e.g. voice) activation of his device. The communication may be provided to a human team member and/or to the team member's device.

RF (radio frequency) communications for all team members is expensive and thus the team may have no more than a few RF devices for communications, i.e. one device for plural members—rather than having devices which are distributed to each team member. It is thus cumbersome or impossible to give or receive different or individual commands to/from different team members. Also, RF communications are easily jammed or detected e.g. by malevolent competitors or hackers from a large distance which may be bothersome to the team unless radio silence is inconveniently maintained throughout normal team functioning. Synchronizing a whole team on to a specific target or destination and simultaneously staying in stealth is challenging, especially if this target or destination were not agreed upon between team members in advance.

Identifying moving objects and/or local positive events and/or local threats to well-being (such as, say, a drone in a crowded urban area). These may be identified visually and/or via sound (often by one team member but not others e.g. if one team member has an earlier line of sight to the local threat than other team members do).

An inadequate solution for this is requiring each team leader to constantly be alert to threats and all the while try to keep track of his team member by means of sight and communicate with a few RF communication devices and voice commands. This is partially effective but time consuming, limiting (e.g. because a team leader can only communicate with team members that have RF communication devices but should not use even that because he might be jammed or detected e.g. by hackers), and does not give a good solution to threat identification.

Certain embodiments provide a system and method for keeping track of an entire team in real-time.

Certain embodiments provide all or any subset of the following to the team: threat limitation and/or localization and/or location marking and/or ability to speak with other team members in natural language and/or automatic tasks and/or automatically giving (typically preconfigured) commands. All or any subset of the following abilities may be provided:
a. Ability to know the location of each device typically without having to provide a GPS or RF device. It is appreciated that GPS is expensive and requires a line-of-sight to satellites which is sometimes impractical e.g. for systems to be used in urban areas which include indoor locations. Typically, the system automatically samples locations of team members and alerts a team leader or a team member if the team member is too far/too close/missing. A single device, e.g. the team leader's device, may be the only device which interrogates all other devices, or all devices may interrogate all other devices.

Typically, devices are configured for transmitting and receiving signals between them, and devices know when they sent their localization request signal (aka localization request aka interrogation) and when the responsive signal was received from device x, and thus can compute their distance from device x, based on the time of the round trip and the known velocity of sound or of transmission.
b. Ability to send commands. Commands may be automatic and/or preconfigured such as “Take cover immediately” if certain threats (e.g. thunder) are identified or “come to device x” if certain assets (events which are positive for the team) are identified. Typically, commands are generated (e.g. are selected from a preconfigured library of commands) without any team member needing to actually speak. This ensures that certain communications are always expressed clearly and efficiently, because the commands are brief (hence rapid and efficient) and uniform, hence easily recognized and clear, as opposed to spontaneous human speech.

According to certain embodiments, a touch of a button can trigger sending specific commands.
c. Ability to speak to other team members, in natural language, which typically cannot be compromised by jammers deployed at a distance from the team.
d. Ability to mark specific targets or locations to home on;
e. Source localization functionality or ability to locate team-relevant event typically having predefined acoustic signatures (e.g. pre-defined threats to wellbeing of team members) and communicate threat locations between task members. If a threat or other team-relevant event, having an acoustic signature, occurs, at microphone/s of least one team member T, may hear the event, and that team member's processing unit e.g. FPGA (used throughout as one possible non-limiting example of a processing unit or hardware processor) may compute the azimuth and distance of the source of the acoustic signals as received and via the speakers of the device give an alert e.g. (to a team of hunters), “rabbit, 250 meters, at 9 o'clock”. This alert is conveyed from the speaker of team member Ts device to other members' devices via ultrasound, alerting the other members of the presence, in the area populated by the team, of the team-relevant event heard by member T.
g. Counting team members and/or acknowledging whereabouts of team members and or performing a roll call and/or taking attendance can be done repeatedly e.g. periodically, and/or automatically and an alert may be provided if a task team member is missing/too far/too close.

Certain embodiments provide a dual-purpose acoustic system which has both team-member localization functionality e.g. as per any embodiment herein, and threat identification functionality (or identification of any other transient, local or moving phenomenon, on any suitable basis e.g. by identifying the phenomenon's acoustic signature), e.g. as per any embodiment herein.

Certain embodiments provide devices with abilities to talk between them e.g. by speaking a voice command, which is then picked up by the microphone, transformed to an ultrasonic frequency and broadcast, or otherwise transmitted. The broadcast is received by other devices which are configured to translate the broadcast back to sonic frequencies, thereby to provide communication between team members as if by radio communications. It is appreciated that due to the short range of ultrasonic devices, such a dual-purpose acoustic system is robust in the sense of being more difficult for malevolent outsiders to detect or block, relative to communication devices having a longer range.

Certain embodiments provide situational awareness to a task force, typically via a small tactical device. This awareness may include all or any subset of task force location or threat identifications. Other functionalities may include target marking and/or communications.

Certain embodiments provide a localization and/or communication system which uses sonic and/or ultrasonic signals to communicate between team members, where each member has a device. Typically, at least one device's hardware processor P is configured to convert speech e.g. commands, captured by at least one processor P's co-located microphone, into ultrasonic signals which travel to a device whose processor P′ is not co-located with processor P and wherein processor P′ is configured to convert the ultrasonic signals, when received, back into sonic signals which are provided to, and played by, the speaker co-located with processor P′, thereby to allow a team member co-located with processor P′ to hear speech uttered by a team member co-located with processor P.

Certain embodiments include an acoustic system which sends a signal. The receiving devices receive the signal and send it back after a delay of duration known to other devices, so the other devices, which know both when the signal was sent and when the signal was received, can compute the distance of the devices. Thus acoustic localization is provided, but time synchronization to know when the signal was broadcast does not require laser/RS SUWIFURF in conjunction with the acoustic system.

The scope of the invention may include any system providing purely acoustic localization that relies on acoustics alone, e.g. according to any embodiment described herein.

The scope of the invention may include acoustic localization outdoors and/or on the move, typically without fixed transmitters and/or without fixed receivers.

The scope of the invention may include any “many to many” system in which plural portable devices each know their own location relative to all other portable devices.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

There is thus provided, in accordance with at least one embodiment of the present invention,

The present invention typically includes at least the following embodiments:

Embodiment 1. A communication system comprising:
plural portable hardware devices which may be distributed to plural team members respectively, each device including at least one speaker and/or at least one microphone, and/or at least one hardware processor, all typically co-located,
wherein the hardware processor in at least one device d1 from among the devices typically controls d1's speaker to at least once broadcast a first signal (“localization request signal”) at a time t_zero, and/or
wherein the hardware processor in at least one device d2 from among the devices typically controls d2's speaker to do the following at least once e.g. each time d2's microphone receives a localization request signal: broadcasts a second signal (“localization response signal”) which is assigned only to d2 and not to any other device from among the plural devices, at a time t_b which is separated by a value deltaT (Δ_T) from a time t_r at which d2's microphone receives the localization request signal and wherein the value deltaT (Δ_T) used by d2, typically each time d2's microphone receives a localization request signal, may be known to the hardware processor in device d1,
and wherein typically, the hardware processor in device d1 at least once computes a distance between d2 and d1 e.g. to monitor locations of other members of a team on the move.

The distance between d2 and d1 may for example be computed by computing time elapsed from time t_zero until a time point t_p at which d1's microphone receives the localization response signal assigned only to d2, subtracting deltaT (Δ_T)to yield a time-interval result, and multiplying the time-interval result by the speed of sound.

The hardware processor may be configured to provide all or any subset of the functionalities and capabilities described herein.

The speaker/s each device has, typically provide omnidirectional or 360 degree coverage.

Typically, the at least one microphone includes at least 3 microphones, thereby to facilitate triangulation and hence to enable each device to discern (typically in addition to its own relative distance), also its own azimuthal orientation e.g. relative to other devices.

Each microphone is typically operative to receive both speech and ultrasonic signals.

From the loudspeakers, typically, both ultrasonic signals (e.g. location request, broadcasting signals, speech commands) and sonic signals like alarms or speech can be sent

The system may provide alerts to at least one team member to indicate wrong distance and/or azimuth when team member/s are not in position and/or are off course.

Typically, acoustic transponders may be used. channel access technology may be used (e.g. to facilitate differentiation), such as CDMA and/or TDMA and/or FDMA. More generally, in order to differentiate or distinguish between the unique signals sent by the various devices or units, each device is typically operative to distinguish its broadcasts. For example, each device may broadcast signals (frequencies and/or patterns), and/or may broadcast at times (e.g. with delays), which differ relative to the frequencies and/or patterns and/or times of broadcast (e.g. delays), of other devices.

Embodiment 2. The system according to any of the preceding embodiments wherein the hardware processor in one device d2 from among the devices controls d2's speaker is configured to do the following each time d2's microphone receives a localization request signal: to broadcast a second signal (“localization response signal”) which is assigned only to d2 and not to any other device from among the plural devices, at a time t_b which is separated by a value deltaT (Δ_T), known to the hardware processor in device d1, from a time t_r at which d2's microphone receives the localization request signal and wherein the same value deltaT (Δ_T) Is used by d2 each time d2's microphone receives a localization request signal.

Embodiment 3. The system according to any of the preceding embodiments wherein plural devices d2 broadcast localization response signals respectively assigned only to them and not to any other device from among the plural devices.

Embodiment 4. The system according to any of the preceding embodiments and wherein the value deltaT (Δ_T)used by any given one of the plural devices d2 is different from the value deltaT (Δ_T)used by any other of the plural devices d2, thereby to reduce interference between plural localization response signals being received by device d1.

For example, team member 1 may send or broadcast a localization response signal deltaT (Δ_T)=K seconds (where K is 3 or 4 seconds, or 20 or 30 milliseconds, any other suitable value) after member 1's microphone receives a localization request signal, and team member 1+n, for all n=1, 2, 3, . . . , may send or broadcast a localization response signal deltaT (Δ_T)=K+n seconds after member n's microphone receives the localization request signal. Thus, the team member sending the localization request may receive, if all other team members are within her or his range, the response signal assigned only to team member 1, after K seconds, then the response signal assigned only to team member 2, after K+1 seconds, then the response signal assigned only to team member 3, after K+2 seconds, and so forth. Generally, if the team member sending the localization request (the “localizing” team member) does not timely receive the response signal assigned only to team member x, the localizing team member may conclude that team member x has gone missing. It is appreciated that many or all team members may be localizing team members. Plural localizing team members may send out localization requests simultaneously, or the plural localization requests may be distributed over time using any suitable typically predetermined scheme to coordinate between the plural localizing team members. It is appreciated that according to any embodiment, all team members may send both localization requests and localization responses.

If desired, all team members may send out identical localization responses rather than unique localization responses, and the determination of whether team member x has gone missing, may be according to the known time after which team member x was supposed to send back a localization response.

Any suitable technology may be employed to select (or customize) k, deltaT (Δ_T)etc. —depending e.g. on how close the team members stay to each other, how many team members there are, what is the use case—e.g. how often is it desired to sample location (every second? Every 10 minutes? etc.), is battery time an important consideration because it is necessary to support an extended time of operations, etc.

Typically, if the time for a “round trip” of a signal at max distance is X seconds, the system is configured to wait at least x seconds before sending another request and/or before determining that a unit or device or team member is missing.

Typically, all possible devices can respond at maximum distance without overlapping. This may depend on the length of the signal being transmitted e.g., say, 300 milliseconds vs., say, 800 milliseconds.

Example: a team has 3 team members (U1, U2, U3). One device (U1) wants to know the location of the other 2 devices (U2, U3) every 10 seconds. The maximum distance between members is 350 meters; the round trip time may be roughly 2 seconds. In this case, the system may be configured as follows:
1. U1 may send a location request signal (or localization request) each 10 seconds
2. U2 may respond in a (1) 35 Khz frequency with a (2) single unique identification pattern lasting 100 milliseconds (3) after 400 milliseconds
3. U3 may respond in a (1) 45 Khz frequency with a (2) single unique identification pattern (e.g. the same pattern used by u2) lasting 200 milliseconds (3) after 3800 milliseconds

The above configuration ensures no collision between times of broadcast, frequencies and signals. Distance and azimuth (e.g. team member azimuthal orientation) may be computed by U1 with reference to the known delay understood e.g. as described herein.

This type of computation may be done for each use case of the system.

Embodiment 5. The system according to any of the preceding embodiments wherein at least one device's hardware processor P is configured to convert speech e.g. commands, captured by at least one processor P's co-located microphone, into ultrasonic signals which travel to a device whose processor P′ is not co-located with processor P and wherein processor P′ is configured to convert the ultrasonic signals, when received, back into sonic signals which are provided to, and played by, the speaker co-located with processor P′, thereby to allow a team member co-located with processor P′ to hear speech uttered by a team member co-located with processor P.

According to certain embodiments, the processor P is trained to recognize each command in a predetermined set of commands including, say, at least one of STOP, TAKE COVER.

Embodiment 6. The system according to any of the preceding embodiments wherein d1's hardware processor is operative to control d1's speaker to send an alert to d2, to be played by d2's speaker, if the distance between d2 and d1 answers a criterion indicating that d2 is almost outside of d1's microphone's range.

It is appreciated that the criterion may be that the distance between d2 and d1 is too large, or may be that d2's trajectory, as indicated by d2's most recent positions as discovered by d1 the last few times that d2 provided localization response signals to d1, indicates that d2's trajectory, if continued, may leave d2 outside of d1's range.

Embodiment 7. The system according to any of the preceding embodiments wherein the system has location marking functionality including providing oral prompts aiding team members to navigate to a location that has been marked.

Embodiment 8. The system according to any of the preceding embodiments wherein the system has homing functionality including providing oral prompts aiding all team members to navigate toward a single team member.

Embodiment 9. The system according to any of the preceding embodiments wherein a team has a known total number of members and wherein the system has roll call or team member counting functionality which provides alerts to at least one team member when a depleted number of team members, less than the known total number of members, is recorded.

Embodiment 10. The system according to any of the preceding embodiments wherein the system has threat detection and localization functionality which provides alerts to at least one team member when a learned acoustic signature of a threat is sensed by at least one team member's microphone.

Embodiment 11a. The system according to any of the preceding embodiments wherein said at least one microphone includes at least 3 microphones, thereby to facilitate triangulation and wherein each device is configured to use triangulation to discern azimuthal orientation of at least one team member.

Embodiment 11b. The system according to any of the preceding embodiments wherein the system provides at least one alert to at least one team member when at least one team member is azimuthally off course.

Embodiment 12. The system according to any of the preceding embodiments which has human-to-human communication functionality which provides team members with an ability to speak to each other in natural language.

Embodiment 13. The system according to any of the preceding embodiments which has device-to-human communication functionality which presents a command provided by an individual team member's hardware processor, to team members other than said individual team member.

Embodiment 14. The system according to any of the preceding embodiments which has device-to-device communication functionality which communicates data generated by an individual team member's hardware processor, to at least one hardware processor in a device distributed to at least one team member other than said individual team member.

Embodiment 15. The system according to any of the preceding embodiments wherein said at least one speaker comprises an array of speakers.

Embodiment 16. The system according to any of the preceding embodiments wherein said at least one microphone comprises an array of microphones.

Embodiment 17. A communication method comprising:
Providing plural portable hardware devices to plural team members respectively, each device including at least one speaker, at least one microphone, and at least one hardware processor, all co-located,
wherein the hardware processor in at least one device d1 from among the devices controls d1's speaker to at least once broadcast a first signal (“localization request signal”) at a time t_zero,
wherein the hardware processor in at least one device d2 from among the devices controls d2's speaker, is configured to do the following each time d2's microphone receives a localization request signal: broadcasts a second signal (“localization response signal”) which is assigned only to d2 and not to any other device from among the plural devices, at a time t_b which is separated by a value deltaT (Δ_T)from a time t_r at which d2's microphone receives the localization request signal and wherein the value deltaT (Δ_T)used by d2 each time d2's microphone receives a localization request signal, is known to the hardware processor in device d1,
and wherein the hardware processor in device d1 at least once computes a distance between d2 and d1
thereby to monitor locations of other members of a team on the move.

Embodiment 18. A computer program product, comprising a non-transitory tangible computer readable medium having computer readable program code embodied therein, said computer readable program code adapted to be executed to implement a communication method comprising:

After providing plural portable hardware devices to plural team members respectively, each device including at least one speaker, at least one microphone, and at least one hardware processor, all co-located,

In the hardware processor in at least one device d1 from among the devices controlling d1's speaker to at least once broadcast a first signal (“localization request signal”) at a time t_zero, In the hardware processor in at least one device d2 from among the devices controls d2's speaker, doing the following each time d2's microphone receives a localization request signal: commanding to broadcast a second signal (“localization response signal”) which is assigned only to d2 and not to any other device from among the plural devices, at a time t_b which is separated by a value delta_t (Δ_t) from a time t_r at which d2's microphone receives the localization request signal and wherein the value deltaT (Δ_T) used by d2 each time d2's microphone receives a localization request signal, is known to the hardware processor in device d1,

and wherein the hardware processor in device d1 at least once computes a distance between d2 and d1, thereby to monitor locations of other members of a team on the move.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing devices which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIG. 1 is a simplified block diagram illustration of a system facilitating efficiency of a group such as but not limited to a team whose team members may or may not include humans on the move, which is constructed and operative in accordance with certain embodiments, and may be provided in conjunction with any embodiment described herein.

Arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

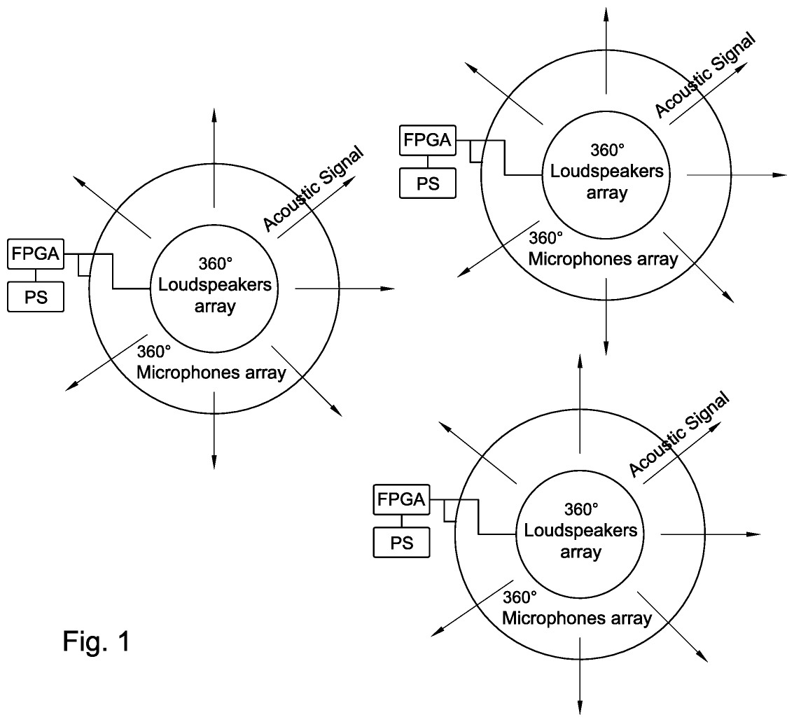

Reference is now made to the system of FIG. 1 which can function as a localization system which allows a moving team to know where each team member is, in real time or near-real time, even without resorting to GPS or RF technologies. The system may serve a moving team including plural members, and may include plural portable e.g. wearable devices, each including at least one of, e.g. an array of, omnidirectional microphone[s] and at least one of, e.g. an array of speakers.

According to certain embodiments, a team, or group of task force members, is equipped with plural devices e.g. one per task force member. Each device may be wearable (by a task force member) or portable or mobile, or on wheels, or airborne. Each device typically includes all or any subset of:

Loudspeaker/s that typically yield omnidirectional or 360° coverage and typically work in sonic and/or ultrasonic frequencies.

At least 2 microphones that typically respond to or correspond to the loudspeakers' frequencies e.g. sonic and/or ultrasonic frequencies.

A power source aka PS; and

A processor such as an FPGA unit typically providing both processing power and memory. An FPGA is a field-programmable gate array which is an example of a device which may be configured by an end-user, customer or designer after manufacturing.

Each device or unit may have external interface/s. The device can be connected to other systems (such as C2 and/or display and/or other interested parties) e.g. via an API.

It is appreciated that more generally, any number of microphones and loudspeakers may be provided, however these typically are selected to provide omnidirectional or 360 degree coverage. Typically, each device can act as a receiver and transmitter, hence each device may be used as a repeater if a mesh network architecture is desired.

According to certain embodiments, each team member's unit or device stores (e.g. in the device's FPGA or other memory) data which is pre-configured or loaded to the system e.g. an indication of all N team members' unique signals, typically associated with the team member's name. It is appreciated that if each device (or a team leader's device) has this data regarding other devices configured in it, the device can, e.g. upon command and/or periodically, broadcast a localization request which all receiving devices are configured to acknowledge. Thus, if a device is missing or is found too far/too close/not in place etc.—an alert can be given.

The device may also store initial locations of the various team members. The device may store topographic data. At least one device may also store a “window” of location info indicating where other team members were at various points in time e.g. where was team member 79, 1 minute ago, 2 minutes ago and 3 minutes ago. A table may be provided for storing the known times (which may be suitably staggered to prevent interference) or frequencies at which the other devices in the team respectively transmit their unique signals. Each table or indication may be loaded in-factory and may be pre-loaded by end-users.

Typically, all N devices are time-synchronized e.g. as described herein. Each of the devices typically transmits an acoustic signal (e.g. an acoustic signal unique to that device which differs from the acoustic signals being transmitted from all other devices), typically at a known time. Typically, the acoustic signal unique to device N is received by all of devices 1, . . . N-1 and similarly, typically, for all other unique acoustic signals which are similarly received by all other devices. The receiving device typically identifies the device which transmitted this unique acoustic signal, then computes the azimuth and distance of that transmitting device based on time and known topography. The above-referenced publication by Bianco, Gannot and Gerstoft describes a possible method for computing azimuth and distance of a transmitting unit based on time and known topography.

Each team member can be equipped with a device.

Prior to operations: all devices are typically mounted e.g. if wearable, by the team-members, and are turned on. Each device may be identified and found to be working and ready for operations.

During operations:
a. Any spoken command is broadcasted and received by other devices.
b. Each interested device U sends a location request, at least once, upon request or occasionally or periodically, say every 1 or 3 or 5 or 10 or 30 seconds, via the loudspeakers. Requests may be specific for a certain ability e.g. commands or localizations.

Each device d that receives this request responds with its unique signal at a sending time which is known (to the device d itself and typically to all or some other team members and/or is predetermined and/or is unique (vis-a-vis all other team members). The sending time typically comprises a time interval which is to elapse before sending, the time interval extending or starting from to the time that device d received the request signal. For example, the time using device d's clock may be 14:08 whereas device U's clock shows the time to be 17:06. Then, if device d receives a location request at 14:08:30, device d is configured to wait 2 seconds (by device d's clock) before sending its own (typically unique) ID. So device d may respond with its own ID at 14:08:32. device U may receive device d's signal ID and know (e.g. be pre-configured) to subtract the 2 seconds that he knows device D is configured to wait, and then compute the distance.

Each such returning signal is received by U and, since signals are unique per device, is identified by U as having been transmitted by a given device U T. U T's relative location e.g. relative to U, is determined by the interested device U. Should interested device U possess location knowledge e.g. as received by a GPS, then all relative locations can be transformed into absolute locations. It is appreciated that a device can interface with any suitable external geo location provider (such as, but not limited to, a GNSS or data given from radars), and thus provide geo locations.

Each device typically stores, in memory, the unique signals of each device in the set of team members, and therefore any device which fails to respond may be identified by comparing unique signals received to the stored unique signals and identifying stored signals, if any, which were not received. If a device fails to respond, or is found to be too far or too close, an alert is given e.g. to the human team member bearing the interested device.

Example: a and b are team members whose devices know they are not to be more than 200 meters away from one another. Each time one of a and b's devices lags behind the other, or takes a wrong turn which separates the 2 devices beyond 200 meters, the next location request may reveal this, and, responsively, members a and/or b can be alerted e.g. via their loudspeakers, that they are too far away from each other. For example, the team leader may periodically be informed that “team member 1 is too far away”.

It is appreciated that each device may include an FPGA or other storage which may be configured by end-users and not only, or not necessarily, in the factory. The FPGA may be used for repeatedly e.g. periodically sending commands, and/or for sampling and understanding sounds from the microphones and/or for identifying threats and/or location requests and/or commands and/or for correlating data with topographic data. Typically, each FPGA's configuration includes the unique ID signal and/or time delay and/or transmission frequency of each device, and/or the signal to send, and/or the topographic data.

A certain team member's device can be placed near a target or a destination and serve as a beacon, marking that location e.g. target or destination, for other devices or devices to home on. In this “marking” use-case, the system is typically operative for marking, typically without spoken commands, of:
destinations where the team seeks to assemble, or
targets which are of interest to the team,
or a distress signal or backup request to other team members.

To do this, the team member's device (aka “marker”) typically sends, at least once, a predefined signal that other devices can home in.

The system herein may undergo certain configurations and/or calibrations in the factory, such as all or any subset of the following:
a. The unique signal of each device may be configured in advance e.g. in the factory.
b. The working frequencies may be configured in advance e.g. in the factory.
c. Certain known commands may be identified typically independently of or in addition to or regardless of speech (such as “STOP”, “TAKE COVER” etc.).
d. The between-member distance which triggers alerts (or any other parameter characterizing functionalities described herein) can be configured in advance e.g. in the factory. for example, before operations, devices may be configured to indicate that since distance between devices is not important, no alerts may be given due to devices being too far from one another. Or, devices may be configured to indicate that the maximum range between any 2 team members or a certain subset of team members, must not exceed, say, 200 meters. Then, during team operation, each time a device is about to exceed this distance limitation and/or each time a device actually does exceed the limitation, an alert can be given to that device or others (e.g. “team member 6—too far away”).
e. The number of devices and identification can be configured in advance e.g. in the factory. Each device can have a specific ID. Each device can transmit a specific signal that is unique only to that device and is not transmitted by any other team member, so that other devices, when they hear the signal, may know which team member it applies to.

It is appreciated that each device may be configured to have a name which the human team members associate with the human team member bearing that device, to ensure that alerts are user-friendly (e.g. “Georgie—too far away” rather than “team member 6—too far away”).

Workflows may include all or any subset of the following:

Location Knowing

Each device can transmit a known and unique signal via the loudspeakers. For example, if a team has N members, N unique signals may be used. More generally, the signal transmitted by device x may be differentiated from the signal transmitted by device y using any suitable technology, e.g. differentiation according to time of transmission and/or differentiation according to frequency of transmission and/or or differentiation in the signal itself.

Typically, the signal is transmitted in the ultrasonic range so as not to be heard by people. The signal is received by the microphones in other devices and sent to the processor. Because the signal is unique, the ID of the device is known. By triangulation, the devices can identify the direction of the transmitting device. If the time of transmission is known—as can be achieved, say, by a 1 PPS signal. time synchronization between devices, or simply responding to an acoustic request by an interested device at a known time—then the distance of the transmitting device can be computed. In this manner, each interested device can know the relative location of each device. The process can be done automatically by the devices, and an alert may be provided each time a device is getting too far or is lost, thus freeing the team leader of the responsibility for monitoring for these eventualities.

A particular advantage of certain embodiments is that even if team members' clocks are totally out of sync, team member x's device can still determine where other devices are, by sending a location request signal to other devices, and determining the delay in receiving responses from various other devices by comparing the time the signal was sent, by x's own clock, to the time responses were received, again by x's own clock.

Further enhancing the accuracy and reliability of the system can be done by adding topographic data such as DTM or DSM files and cross-referencing the acoustic signal with them using conventional methods such as described in the above-referenced Bianco, Gannot, and Gerstoft publication.

typically including overcoming multipath, which may be present e.g. in an urban environment, by means of topographic data incorporation. According to certain embodiments, a team member device knows its own location and has topographic data. That device can be trained to understand how a sound located from each position is received. A device can thus be trained, and can then discern, which sound was received, and determine the location of that sound's source.

Communications

Each device can hear spoken commands of the device carrier (such as “STOP”, “Move in <direction>”, etc.) via the microphones. The device can transform the command to the ultrasonic frequencies, and amplify and transmit it via the loudspeakers.

The commands are received via the microphones in receiving devices and are transformed back to the sonic frequencies which can be heard by the receiving device carrier.

In this manner, spoken commands can reach each team member in the team, even if they are beyond speaking range. It is appreciated that an ultrasonic range, which is larger than a speaking range, e.g. an ultrasonic range of several hundred meters e.g., say, 200 or 300 or 400 or 500 meters, is achievable once the volume at which the device loudspeakers transmit and the sensitivity of the receivers or microphones are suitably selected as is known in the art e.g. as described here:

https://www.omnicalculator.com/physics/distance-attenuation

Example: for a given use-case, the devices may be designed such that Tx in the US is, say, above 100 SPL, and MIC sensitivity is, say, at least −60 dB.

Thus, team members need not stay within speaking range in order to exchange oral communications in natural language; instead they need only stay within ultrasonic range.

Specific commands or “words” can be pre-defined and distributed between devices, whether spoken or not (such as: “Drone Alert”, “Obstacle Detected”, etc.) this may enable extremely quick notifications and communications without the need of carrier intervention or acknowledgment.

Threat Identification

Threats or other phenomena with acoustic signatures (sound attributes characteristic only of a certain threat, such as a drone or animal or emergency vehicle siren or speeding car or other event or object (e.g. paintball gun) having an acoustic signature which may be known to the system) can be automatically detected by a device which can then alert the human carrier of the device that this threat is present. Typically, each device's FPGA has been pre-trained or embedded or equipped with logic or an algorithm configured to recognize certain threats having certain acoustic signatures, and is able to classify incoming sounds as being either indicative, or not indicative, of the pre-learned threats.

It is appreciated that phenomena need not necessarily be detected acoustically and may be detected by humans or using any suitable sensor. For example, given a team of hunters, an animal which is permitted by law for hunting may simply be detected, visually, by a human hunter. It is appreciated that the hunter may prefer not to raise his voice, so as not to scare off the animal, however embodiments herein allow the hunter to communicate the presence of the animal, either via a command or by low-volume natural speech which is communicated to afar ultrasonically, without calling out to other members of the hunting team.

The device may instantly identify a threat (or other team-relevant event which may also be positive for the team e.g. presence of running water) e.g. as described herein and may immediately communicate e.g. broadcast that event's presence, and typically its location, to other devices. If several devices identify a threat or other event with the same signature at the same time, the data from all devices identifying the threat are typically gathered or combined and may undergo triangulation, thereby to localize the threat and enhance confidence and accuracy, since the more devices triangulate a threat, the more accurate is the location of the threat as computed by the various devices which have identified or sensed the threat.

A method for locating a threat acoustically, e.g. via microphones, and computing direction is described in:

http://www.conforg.fr/cfadaga2004/master_cd/cd1/articles/000658.pdf
the disclosure of which is hereby incorporated by reference.

Marking:

A device can aid in alerting to a target or desired location that can be stored in advance or decided on the move. For example, e.g. if topographical data and or absolute location (such as latitude/longitude) is known—a location can be marked and even navigated to. Navigation prompts may include beeps or spoken feedback and/or commands and/or help team members to mark points of interest on the move such as:
1. aim/look towards a location
2. caution regarding (moving) objects of interest e.g. fast-moving objects or perilous objects
3. mark targets' locations

Homing:

A device can serve as a “Homing Device” and homing functionality facilitates convergence of all devices to the location of that device. For example, a team is at a certain location, and wants another force to team up with. The device can broadcast a “homing signal” that other devices can get alerts to go to. Alerts can be in the form of spoken commands via the loudspeakers (right/left/forward, and/or a beeping sound which “signals whether the device trying to come home is “hot or cold” e.g. by changing (in volume/frequency/intervals) as a monotonic function of the direction leading to the homing device, and/or changing (in volume/frequency/intervals) as a monotonic function of the distance from the homing device. In this manner, relevant team member/s can home conveniently because navigation to the homing device's location is provided, without sending coordinates or explanations.

Commands:

Commands can be spoken and/or may be generated automatically.

Commands like “Stop”/“Take Cover”/“Deliver (Shoot) The Paintball” (or deliver the pesticide or package or any other substance) can be spoken (sonic frequencies) to a device which may transmit them in ultra-sonic and high volume. A library of pre-recorded commands may be provided. Other devices may receive the command in the ultrasonic frequencies, transform back to sonic, and transmit via their loudspeakers, thereby to provide an oral command to device/s in the team. Known commands can be spoken, the device may understand them and send a preconfigured signal to other devices e.g. “STOP” may be heard, translated into a specific signal, and broadcasted. Other devices may hear the signal and may transmit the known signal via the loudspeakers (prerecorded, or just by beeping).

It is appreciated that some commands may be sent and responded to, automatically between the devices. For example, counting team members or performing a roll call or taking attendance may be automatic; each device may periodically, or on occasion, send a “COUNT” command. Responsively, each device may respond with its ID and thus each device's relative whereabouts can be determined. In this manner, if a specific device is too far/close/not in position, an alert can be sent.

A particular advantage of certain embodiments is that all or any subset of the following abilities may be provided in a single system: detection of positive events and/or threats, marking, homing, speech, commands, team member counting or performing a roll call or taking attendance. For example, threats in the sonic and ultrasonic domains, to team members' wellbeing or to the team's objective, may be heard, identified and localized.

Another advantage is that any embodiment of threat detection herein may be used to acoustically detect threats to wellbeing or to a team's objective, standalone or to cost-effectively and efficiently augment a radar (say)-based threat detection system e.g. to yield a system which has alternative threat detection capability in the event that the RF threat detector is functioning poorly, or not at all.

Chirp signals may be used as localization responses aka localization response signals, according to certain embodiments; more generally, any suitable pattern may be used for localization signals.

Localization may take into account topographical data. Any suitable technology may be used for topographical data-based localization of objects within a terrain whose topography is learned e.g. as described in https://www.research-collection.ethz.ch/bitstream/handle/20.500.11850/9130/eth-7853-01.pdf?sequence=1 or

https://pdfs.semanticscholar.org/9cf4/111c9e6d605a9a7ddef1213aed42d8a08b9b.pdf or in the above-referenced publication by Bianco, Gannot and Gerstoft.

For example, if the system is being used in an intercity area which has highways and throughways which include tunnel portions, then due to signals having been generated in a soundproof tunnel, a team member and his device who are adjacent the tunnel, might hear 2 signals ostensibly arriving from one or both of the tunnel's 2 ends. However, if an AI system stored in the device has been pre-trained with topographical data including the tunnel, the AI subsequently knows that the sound originated in the tunnel and is a single signal, rather than 2 signals.

Any suitable training data may be used e.g. DTM and/or DSM data.

Many variations are possible. For example, any embodiment herein may use any suitable conventional technology for source localization, to localize which threat or team member is the source of a given received signal.

Indoor and/or outdoor operation may be provided; the system may be configured e.g. as described herein for use on the move—no fixed location of Tx or Rx need be assumed or relied upon. Typically, problems which may hamper acoustic systems on the move such as multipath and echoes, which may occur, because when moving in built-up or complex terrains, the acoustic signal tends to bounce hence be changed, may be overcome e.g. by PRE-learning the topography of the region in which the team intends to operate.

Clock indifference may be provided since there is no need for common time between devices e.g. as described herein.

Many to many capability (all devices aware of all devices) may be provided. The system may have an ability to perform automated tasks other than location marking, homing, team counting (or performing a roll call or taking attendance), localizing and alerting for being azimuthally off-course, which are tasks described herein merely by way of example. For example, any device (or unit) in the system may have an ability to alert other devices of moving objects of interest such as a drone detected by one of the team members' devices. Optionally, the system may be configured to display data and/or “tell” data in form of beeps or vibrations or an external data interface. Optionally, the system may add or use data from external sensors such as GPS or temperature or humidity sensors. The system may provide the flexibility to configure devices as per required.

The system and methods herein have wide applicability, in land, air or sea, e.g. for any of the following use cases, separately or in combination:
a. Fleets e.g. of vehicles or drones or personnel or robots or human service providers, which may be answering service calls from a public to be served, and may be competing with other fleets
b. Games, which may be adversarial e.g. paintball, which require teams to move over terrain
c. Sports e.g. mountain-climbing, cross-country skiing etc.
d. Monitoring even stationary fleets of objects e.g. ascertaining that valuable museum exhibits are not being moved, trees are not being felled, etc. by treating each painting (say) as a team member and alarming if any team member's location, as derived from the localization response that team member sends, deviates from that team member's known location (e.g. painting x is known to be hung in a certain location in a certain room within the museum).
e. Preventing theft of animals by treating each animal in a herd as a team member and providing an alert to remote law enforcement personnel, if any team member's location, as derived from the localization response that the team member sends, deviates from the known location of the herd.
f. Crew or team management e.g. for crews of construction workers or health workers or mining workers, who may be working in an area in which threats (say: a collapsing structure) to the crew's wellbeing and/or objective, may occur.
g. hunting teams
h. any team whose members sometimes need to rapidly (e.g. by an oral call, perhaps in natural language) gain the attention of one or some or all other members of the team.
i. any team whose members sometimes need (e.g. by an oral call, perhaps in natural language) to gain the attention of one or some or all other members of the team, in a discrete manner e.g. without calling out loudly to other team members e.g. because the content of the call is confidential due to privacy laws for example. For example, even within a hospital, unexpected emergencies occur and it is sometimes desirable to immediately summon nearby personnel, preferably without disclosing, to members of the public within earshot, confidential information regarding any patient.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment, as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients e.g. mobile communication devices, such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may for example comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

Features of the present invention, including operations which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g. wired data communication and/or in short-range radio communication with sensors such as cameras e.g. via WiFi, Bluetooth or Zigbee.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include an apparatus, whether hardware, firmware or software, which is configured to perform, enable or facilitate that operation, or to enable, facilitate or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art.

Each element, e.g. operation described herein, may have all characteristics and attributes described or illustrated herein, or, according to other embodiments, may have any subset of the characteristics or attributes described herein.

1-23. (canceled)

24. An acoustic many-to-many localization, communication and management system serving a group whose members are moving or maneuvering, the system comprising:
plural portable hardware devices which may be distributed to plural group members respectively, each device including at least one array of speakers, at least one array of microphones, and at least one hardware processor, all co-located,
wherein at least one device's hardware processor P is configured to convert speech e.g. commands, captured by at least one processor P's co-located microphone, into ultrasonic signals which travel to a device whose processor P′ is not co-located with processor P and wherein processor P′ is configured to convert the ultrasonic signals, when received, back into sonic signals which are provided to, and played by, the speaker co-located with processor P′, thereby to allow a group member co-located with processor P′ to hear speech uttered by a group member co-located with processor P.

25. The system of claim 24 wherein the hardware processor in one device d2 from among the devices controls d2's speaker is configured to do the following each time d2's microphone receives a localization request signal: to broadcast a second signal (“localization response signal”), at a time t_b which is separated by a value deltaT, known to the hardware processor in device d1, from a time t_r at which d2's microphone receives the localization request signal and wherein the same value deltaT is used by d2 each time d2's microphone receives a localization request signal.

26. The system of claim 24 wherein plural devices d2 broadcast localization response signals respectively assigned only to them and not to any other device from among the plural devices.

27. The system of claim 24 wherein the hardware processor in at least one device d1 from among the devices controls d1's speaker to at least once broadcast a first signal (“localization request signal”) at a time t_zero,
wherein the hardware processor in device d1 at least once computes at least one of angle and distance between d2 and d1 thereby to monitor locations of other group members who may be on the move.

28. The system of claim 24 wherein d1's hardware processor is operative to control d1's speaker to send an alert to d2, to be played by d2's speaker, if the distance between d2 and d1 answers a criterion indicating that d2 is almost outside of d1's range.

29. The system of claim 24 wherein the system has location marking functionality including providing oral prompts aiding group members to navigate to a location that has been marked.

30. The system of claim 24 wherein the system has homing functionality including providing oral prompts aiding all group members to navigate toward a single group member.

31. The system of claim 24 wherein a group has a known total number of members and wherein the system has roll call or group member counting functionality which provides alerts to at least one group member when a depleted number of group members, less than the known total number of members, is recorded.

32. The system of claim 24 wherein the system has threat detection and localization functionality which provides alerts to at least one group member when a learned acoustic signature of a threat is sensed by at least one group member's microphone.

33. The system of claim 24 wherein said at least one microphone array includes at least 3 microphones, thereby to facilitate triangulation and wherein each device is configured to use triangulation to discern azimuthal orientation of at least one group member.

34. The system of claim 33 wherein the system provides at least one alert to at least one group member when at least one group member is azimuthally off course.

35. The system of claim 24 which has human-to-human communication functionality which provides group members with an ability to speak to each other in natural language.

36. The system of claim 24 which has device-to-human communication functionality which presents a command provided by an individual group member's hardware processor, to group members other than said individual group member.

37. The system of claim 24 which has device-to-device communication functionality which communicates data generated by an individual group member's hardware processor, to at least one hardware processor in a device distributed to at least one group member other than said individual group member.

38. The system of claim 24 wherein said at least one speaker comprises an array of speakers.

39. The system of claim 24 wherein said at least one microphone comprises an array of microphones.

40. The system of claim 24 wherein the device may be operated only after an authorization process.

41. The system of claim 24 wherein the value deltaT (Δ_T) used by any given one of the plural devices d2 is different from the value deltaT (Δ_T) used by any other of the plural devices d2, thereby to reduce interference between plural localization response signals being received by device d1.

42. An acoustic many-to-many localization, communication and management method serving a group whose members are moving or maneuvering, the method comprising:
providing plural portable hardware devices for distribution to plural group members respectively, each device including at least one array of speakers, at least one array of microphones, and at least one hardware processor, all co-located, wherein the hardware processor in at least one device d1 from among the devices controls d1's speaker to at least once broadcast a first signal (“localization request signal”) at a time t_zero; and
wherein the hardware processor in device d1 at least once computes at least one of angle and distance between d2 and d1 thereby to monitor locations of other group members who may be on the move.

43. A method according to claim 42 and wherein at least one device possesses independent location knowledge and wherein at least one group members relative location monitored by the method is transformed into an absolute location using said independent location knowledge.

44. A method according to claim 43 wherein said independent location knowledge comprises GPS data.

45. A method according to claim 43 wherein localization of all group members is provided even while on the move, using only one reference device.

46. A method according to claim 42 and wherein all relative locations are transformed into absolute locations, thereby to facilitate localization of all group members even while on the move, using but a single reference device.
